(19) United States
(12) Patent Application Publication
(10) Pub. No.: US 2009/0209680 A1
(43) Pub. Date: Aug. 20, 2009

(54) Process for preparing a nanocomposite rigid material

(75) Inventors: Anne-Cecile Grillet, Le Montcel (FR); Tan Tai Dang, Ho Chi Minh Ville (VN); Ha Thuc Huy, Ho Chi Minh Ville (VN); Gerard Merle, La Chapelle Du Mont du Chat (FR)

Correspondence Address: YOUNG & THOMPSON, 209 Madison Street, Suite 500, ALEXANDRIA, VA, 22314, US

(73) Assignee: CENTRE NATIONAL DE LA RECHERCHE SCIENTIFIQUE (C.N.R.S.), Paris (FR)

(21) Appl. No.: 11/943,811

(22) Filed: Nov. 21, 2007

(30) Foreign Application Priority Data
Nov. 21, 2006 (FR) 06/10183

(51) Int. Cl. C08J 3/20

(52) U.S. Cl. 523/322

(57) ABSTRACT

The invention relates to a process for preparing a material consisting of a PVC matrix reinforced with clay comprising the following successive stages:
(1)) preparation of a modified clay by mixing a natural clay with a non-volatile solvating compound, the mixture being carried out by applying at least one of the following mechanical stresses:
   compression, at a speed of between 0.01 and 0.05 m/s;
   shear, at a speed of between 0.05 and 5 m/s;
   friction, at a speed of between 0.05 and 5 m/s;
   attrition, at a speed of between 2 and 4 m/s;
(2) incorporation of the modified clay into the PVC by mixing in the molten state, the implementing conditions being such that:
   the speed of compression is between 0.1 and 5 m/s;
   the speed of shear is between 0.05 and 5 m/s.

### FIELD OF THE INVENTION

The present invention relates to a process for preparing a nanocomposite rigid material consisting of a clay-reinforced PVC matrix.

### BACKGROUND OF THE INVENTION

PVC is a material which is widely used, especially in the form of rigid PVC, in the field of building construction.

Rigid PVC compositions usually contain, in addition to PVC, mineral fillers, additives for impact resistance consisting of copolymers, especially in the form of particles, heat stabilisers and other implementing constituents.

A high degree of rigidity and a thermally insulating nature are desirable properties in rigid PVC-type materials used in joinery work. Good rigidity is obtained by choosing a shape suitable to the PVC pieces. However, the rigidity thus obtained is not always satisfactory.

Attempts have been made to remedy this situation by adding steel backer rods. However, said process is complicated to carry out.

Incorporating fibrous fillers has also been attempted, but the state of the resultant surface of the manufactured pieces is not satisfactory.

Furthermore, a known method for improving some properties of polymer materials, for example, mechanical properties (rigidity, impact resistance) or fire resistance, consists in incorporating a bladed mineral filler (clay, for example) into a polymer matrix to produce nanocomposite materials in which the filler is dispersed in the form of nanoparticles. Said reinforced materials can then usually be transformed by the conventional processes such as extrusion or assembly by heat welding.

So that a clay may be incorporated into a polymer material to form a composite material, the clay must be organophilic. Natural clays do not have this property.

Furthermore, the use of a clay wherein the interlayer distance has been increased by total or partial exfoliation is advantageous for obtaining filler distribution on the nanometric scale in the “mineral filler/polymer” composite material.

Different solutions are proposed in the prior art for obtaining one and/or the other of the preceding results, but they are not entirely satisfactory.

Indeed, clays which have been rendered organophilic by conventional methods through ion exchange, in particular those having ammonium ions, lead to degradation of the rigid PVC formulations when they are employed.

The present invention aims at remedying the drawbacks of the earlier techniques.

The properties of a material depend on its composition, but also heavily on the structure of the mixture on all scales: from the nanometric scale to that of the finished object. Thus the process of mixing the constituents of the material is also conceived as a material structuring process, which makes it possible to optimise the relationship between the composition and structural combination of properties.

### SUMMARY OF THE INVENTION

To this end, the invention provides a process for preparing a material formed of a clay-reinforced PVC matrix, characterised in that it comprises the following successive stages:

(1) preparing a modified clay by mixing a natural clay with a non-volatile solvating compound, the mixing being carried out using at least one of the following mechanical stresses:
compression, at a speed of between 0.01 and 0.5 m/s;
shear, at a speed of between 0.05 and 5 m/s;
friction, at a speed of between 0.05 and 5 m/s;
attrition, at a speed of between 2 and 4 m/s;
   (2) incorporating the modified clay into the PVC by mixing in the molten state, the conditions for carrying out the mixing being such that:
the compression speed is between 0.1 and 5 m/s;
the shear speed is between 0.05 and 5 m/s.

Operating conditions of this type result in the viscous mixture having:
an average shear rate of 10 to 1000 s⁻¹;
dispersive mixing conditions, more precisely a field of shear capable of varying by at least a factor 10;
and a field of shear at least equal to 10⁴ Pa.

Indeed, the particle disintegration results from the viscous stress, which the polymer puts on the clay particles; said stress is the product of the shear rate multiplied by the viscosity of the polymer. The corresponding values are at least 10 s⁻¹ for the shear rate, and at least 10³ Pa·s (typically 10⁴) for the viscosity, in the mixing conditions.

Moreover, since a simple shear flow is not suitable for disintegrating particles in a polymer matrix, the mixing conditions must be dispersive, in other words, they must produce areas of weak stress as well as areas of strong shear, in addition to an elongational stress (converging-diverging) such as that obtained between two contra-rotating blades.

The first stage of the process according to the invention is to incorporate the solvating compound into the clay, said compound having the effect of solvating the alkali ions of the clay and increasing the interlayer distance.

Said mixing stage can be carried out by grinding and trituration, for example, using a pestle and mortar-type device or a ball grinder or ball mill (this type of material lending itself well to the grinding-trituration-mixing combination of products which are not hard and which have small particle-size distribution corresponding to stage 1), or an internal mixer (a Brabender or other type), or any other device capable of providing mixing conditions as defined above. In the pestle and mortar-type device for example, where there is friction between the pestle and mortar, the mixture is thus stressed as the “third body” in accordance with the definition of tribology.

During the first stage, the temperature is preferably ambient temperature. There is therefore no intentional external heating during said first stage, thereby limiting the fluidification of the solvating compound in the mixture, which can occur with a rise in temperature. Indeed, the viscosity of the solvating compound acts upon the modification of the clay under the effect of trituration.

One compromise is to refine, among the various mixing parameters, the time, temperature and a possible post-treatment process. Especially, one possible post-treatment process can consist in bringing the mixture to a temperature which is greater than the fusion temperature of the solvating compound after mixing, if mixing has been carried out at a lower temperature. There is thus a compromise between the mixing, which is aided by the low viscosity, and post-treatment at higher-temperature which aids completion of the reaction.

Various tests can be carried out in order to monitor the quality of the result obtained during the first stage, in other words, the quality of the modified clay:
modification of the clay is monitored using X-ray diffraction, which makes it possible, on the one hand, to show that the diffraction lines of the initial clay have disappeared and, on the other hand, that a new structure has appeared. For example, when the solvating agent is capable of providing two different structures corresponding to the different interlayer distances, the occurrence of one, the other or both structures is checked simultaneously, the structure in which the interlayer distance is greater being preferred;
dissipation of the solvating compound which has remained free is monitored by X-ray diffraction or differential enthalpic analysis (DSC);
measurement of the particle-size distribution is also monitored to evaluate the result of the mixing process as well as the subsequent stages. It is preferable that the modified clay particles be of a size approximately less than 100 μm, said value allowing the agglomerates formed during contact with the mixing constituents to be reduced to a sufficiently small size by grinding; said size is obtained directly via the process, or, if necessary, after screening.

The second stage of the process according to the invention is to incorporate the modified clay obtained in stage (1) into the PVC. This stage can be carried out in order to obtain the mixing conditions defined above, for example, by mixing in a Banbury-, Brabender-, Haake- or other type internal mixer with interpenetrating blades and a peripheral blade speed of between 0.05 and 1 m/s, or by extrusion in a single- or double-screw extruder, or by dynamic compaction injection moulding.

The temperature is that suitable for transforming rigid PVC (150 to 190° C.).

One compromise is to refine, among the formulation and the various mixing parameters, the time and temperature, in order to obtain all the desired properties (rigidity, impact resistance, aspect, etc.) according to the type of structure desired for the material, in particular the quality of the disintegration and relatively fine and complete dispersion of the clay.

Among the parameters of the second stage of the process, the shear stress conditions, more specifically the shear stress imposed inside the mixture under the combined effect of the field of shear speed and viscosity of the polymer, are adapted to obtain, on the one hand, disintegration of the clay particles and, on the other hand, dispersion thereof and homogeneity of the mixture, whilst avoiding degradation thereof. PVC heat degradation or thermomechanical degradation, and degradation of the clay are all to be avoided.

It is known that, depending on its intensity, the grinding of the clays leads first to delamination, then fragmentation of the layers, then destruction thereof. It is also known that excessively severe mechanical conditions during mixing of the PVC leads to mechanochemical degradation, which arises through an increase in the torque of the kneader during mixing.

The torque measured on the mixer used is an overall indication of the stress: for example, for a PVC, the viscosity of which at 180° C. varies between 10⁶ and 10⁴ Pa·s for shear gradients with values of 10 and 10⁴ s⁻¹ respectively, the torque is approximately 30 Nm at 30 revolutions per minute.

The intensity of the mixing treatment in the second stage of the process according to the invention, calculated from the product of the torque multiplied by the time period, is therefore regulated by the action on the following parameters: temperature (affecting the viscosity), speed of rotation and rate at which the mixer is filled (affecting the shear), and duration.

The PVC obtained by the process according to the invention has new properties, in particular improved mechanical and viscoelastic properties.

The impact resistance is aided by a combination of the formulation and the mixing conditions which leads to a dissipative network and incomplete exfoliation of the clay. Said combination is obtained by limiting the disintegration of the clay particles to small groups of layers called “primary particles”. This type of material structure shown by microscope and a specific viscoelastic performance, results from the manufacturing conditions of the material.

Advantageously, the solvating compound is a polymer. Polyoxyethylene (POE) and polyethyleneimines (PEI) are particularly preferred.

If the solvating compound is POE, the clay/POE ratio by weight used in the first stage is in the region of 10/1 to 10/10, preferably 10/1 to 10/5, advantageously from 10/1 to 10/2.

The molar mass of the polymer used as a solvating agent is a parameter for regulating the desired properties. Generally, the impact resistance properties are improved by high molar masses (for example, a POE with a molar mass of 100,000 g/mol), and the optical and aspect properties are improved by the low molar masses.

The natural clay used can be a smectite (for example, a montmorillonite (MMT) or a bentonite), a hectorite or a vermiculite.

### BRIEF DESCRIPTION OF THE DRAWINGS

These and other features of the invention will become apparent, from consideration of the accompanying drawings, in which:

FIG. 1a shows, from top to bottom, the w-ray detraction patterns for the uncombined clay dried at 200^{c} for 200 minutes, for the uncombined POE, and for the clay-POE mixture;

FIG. 1b is similar to FIG. 1a but shows the x-ray detraction pattern of the uncombined clay dried at 250^{c} for 200 minutes;

FIG. 2 shows the results of analysis by DSC, of the mixed product;

FIGS. 3a and 3b show the x-ray detraction patterns for the uncombined clay and for the clay-PEI mixture;

FIG. 4 shows, from top to bottom, the x-ray detraction patterns obtained for the modified clay, consisting of the clay-POE mixture in a 10/1 ratio for the uncombined PVC for the PVC-modified clay mixture in the 100/3 ratio, and for the PVC-modified clay mixture in a 100/5 ratio;

FIG. 5a shows the results for three formulations at ratios of 1, 3 and 5 parts per 100;

FIG. 5b shows, from top to bottom, the results for the PVC-modified clay mixture in ratios of 100/5, 100/3 and 100/1, respectively;

FIG. 5c shows the mechanical loss factor as a function of character, in the glass transitions of the materials;

FIG. 6 shows various curves illustrating impact resistance;

FIG. 7a shows the different impact strength values; and

FIG. 7b shows different tensile strength values.

### DETAILED DESCRIPTION OF THE INVENTION

According to a preferred embodiment, a montmorillonite is used, with a POE as a solvating compound.

The following examples are intended to illustrate the invention without limiting the scope thereof.

In Examples 2 to 6, and 8 to 13, the Brabender internal mixer used provides, at 30 revolutions per minute, a field of shear ranging between 5 and 80 s⁻¹ for an average rate of approximately 13 s⁻¹. Furthermore, during the second stage of the process, the torque remains in the range of 10 to 50 Nm, the mixing speed is from between 30 and 50 revolutions per minute and the mixing duration varies from 4 to 60 minutes.

### Example 1

### Modification of a Montmorillonite-Type Clay Using Poly(Ethylene Oxide)—“Pestle and Mortar” Method

### Procedure

The clay used is a commercial montmorillonite, marketed by Süd Chemie (Germany), under reference number N757.

The POE used is marketed by Aldrich. It has a molar mass of 1,500 g/mol.

The clay is initially dried at 250° C. for 200 minutes in order to dispose of the water it contains, then it is mixed with the desired quantity of POE by grinding in a mortar with a diameter of 80 mm, at approximately 60 revolutions per minute, the mixture ratio being 3 g of POE to 10 g of clay.

Thus, after 20 minutes' grinding in the mortar at ambient temperature, with a friction-shear speed of approximately 0.2 m/s, the mixture is homogeneous. The homogeneous nature of the mixture is checked by determining the size of the particles in the mixture using screening with a mesh size equal to 112 μm, said value being chosen so that the agglomerates formed during contact of the constituents in the mixture are reduced to a sufficiently small size by grinding.

The mixture is then placed in a furnace at 90° C. for 8 hours so that the molten POE can be interspersed into the clay galleries.

### Results

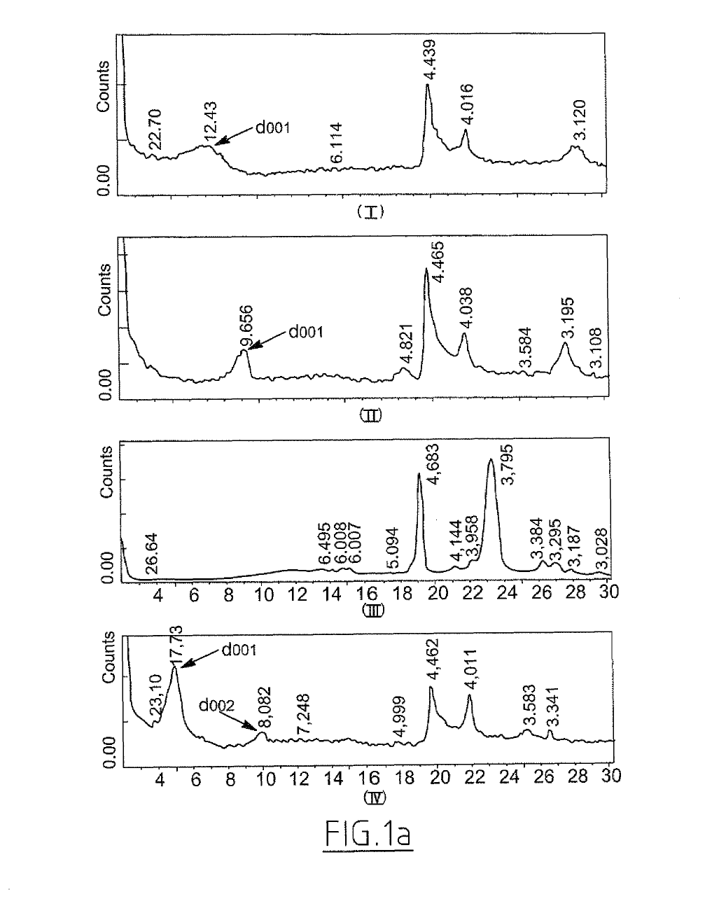

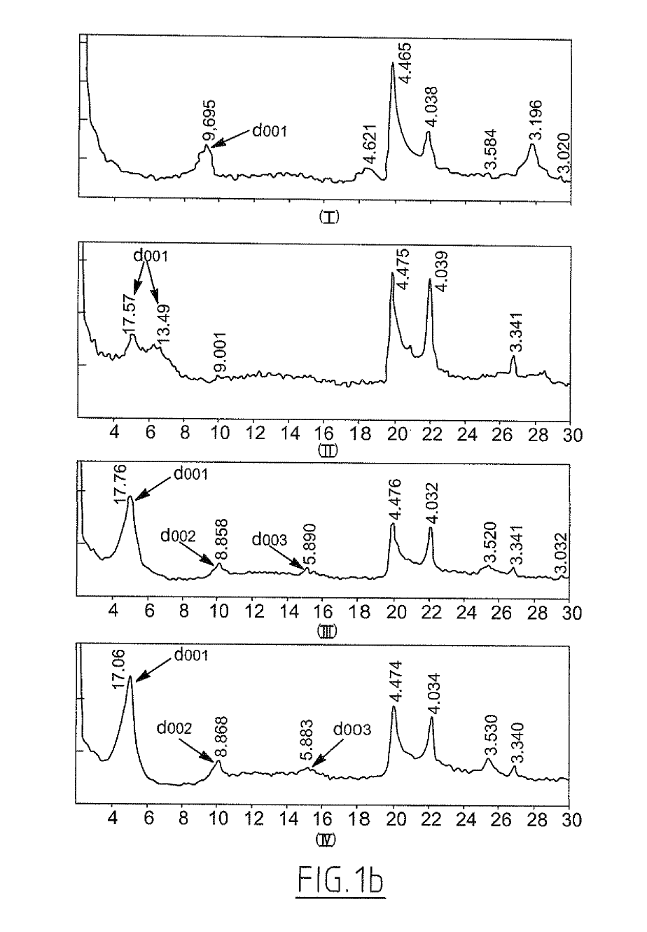

FIG. 1a) shows, from top to bottom, the X-ray diffraction patterns (K_{α} copper line: λ=0.154 nm) for the non-dried uncombined clay (X-ray diffraction pattern I), for the dried uncombined clay at 250° C. for 200 minutes (X-ray diffraction pattern II), for the uncombined POE (X-ray diffraction pattern III) and for the clay-POE mixture (X-ray diffraction pattern IV).

The peak corresponding to d₀₀₁≈1.24 nm (calculated for the test value 2⊖≈7° by Bragg's law λ=2d sin θ) of the uncombined N757 prior to drying matches the results in the literature relating to the effects of humidity on clays (for example, S. Varghese, J. Karger-Kocsis, K. G. Gatos; Polymer; 44 (2003) 3977-3983). After drying at 250° C. for 200 minutes, the bulk of the molecular water between the N757 layers evaporated. The d₀₀₁ value of N757 decreased and reached the value of 0.97 nm, corresponding to 2⊖≈9°.

Knowing that the standard interlayer distance of natural montmorillonite is d₀₀₁=0.96 nm, it is possible to deduce that after drying practically all the water was eliminated, the N757 thus having the standard natural montmorillonite structure.

After mixing the N757 and the POE₁₅₀₀, the peak d₀₀₁=0.97 nm of the uncombined N757 disappeared and a new peak of d₀₀₁=1.77 nm appeared, for a value of 2⊖≈5°. This shows that the POE was inserted between the N757 layers, the d₀₀₁ therefore rose from 0.97 nm (for the uncombined N757) to 1.77 nm (for the N757-POE mixture). In addition, the peaks (002) and (003) can be observed, which shows that the crystalline structure is well organised.

The two peaks which are characteristic of the crystalline POE, at 2⊖=19.1° and 2⊖=23.3°, also disappeared after mixing with the N757. This suggests that the POE was not able to crystallize in the N757-POE mixture, since the POE is inserted into the N757 galleries. The interaction between the POE and the polar groups on the surface of the N757 layers precluded free crystallization of the POE.

It can therefore be concluded that the POE was well inserted in the N757.

Such a result is also obtained, on the one hand, by varying the molar mass of the POE between 10,000 and 100,000 g/mol and, on the other hand, by varying the montmorillonite/POE mass ratio between 10/1 and 10/10. By way of example, FIG. 1b shows the effect of the rate of POE with a mass of 1,500 g/mol on the structure of the mixtures, for N757/POE mass ratios equal to 10/1 (X-ray diffraction pattern II), 10/3 (X-ray diffraction pattern III), 10/5 (X-ray diffraction pattern IV) respectively. By way of comparison, FIG. 1b also shows the X-ray diffraction pattern of the uncombined clay dried at 250° C. for 200 minutes (X-ray diffraction pattern I).

The XRD spectra show that the two possible structures of POE inserted into the clay can occur, corresponding respectively to the d₀₀₁ distances 1.77 and 1.35 nm.

### Example 2

### Modification of a Montmorillonite-Type Clay Using Poly(Ethylene Oxide)—“Direct-Brabender” Method

### Procedure

A POE with a molar mass of 100,000 g/mol, the fusion temperature of which is 67° C., was mixed directly with the N757 clay (N757/POE_{100,000} mass ratio=10/3) in a Brabender mixer at 90° C., at 50 revolutions per minute for 30 minutes. The product was analysed using X-ray diffraction.

Said method known as “Direct-Brabender” provides a result identical to the “pestle and mortar” method. With the two mixing methods, the N757-POE d₀₀₁ peak is the same value of 1.77 nm. Therefore, the method has no effect on the insertion. However, the “Direct-Brabender” method is easier and quicker to carry out.

### Example 3

### Optimisation of the Process in Example 2

### Effect of the Mixture Mass

Of the main parameters determining the mixing conditions in the internal mixer, filling the mixing chamber plays a significant role: if the chamber is not full, mixing is far less extensive than were it full, since the shear therein is not as strong.

Tests have been carried out, introducing into the mixing chamber different masses of the N757-POE mixture (total mass=26 g, 46 g and 60 g), which were prepared according to the procedure described in Example 2.

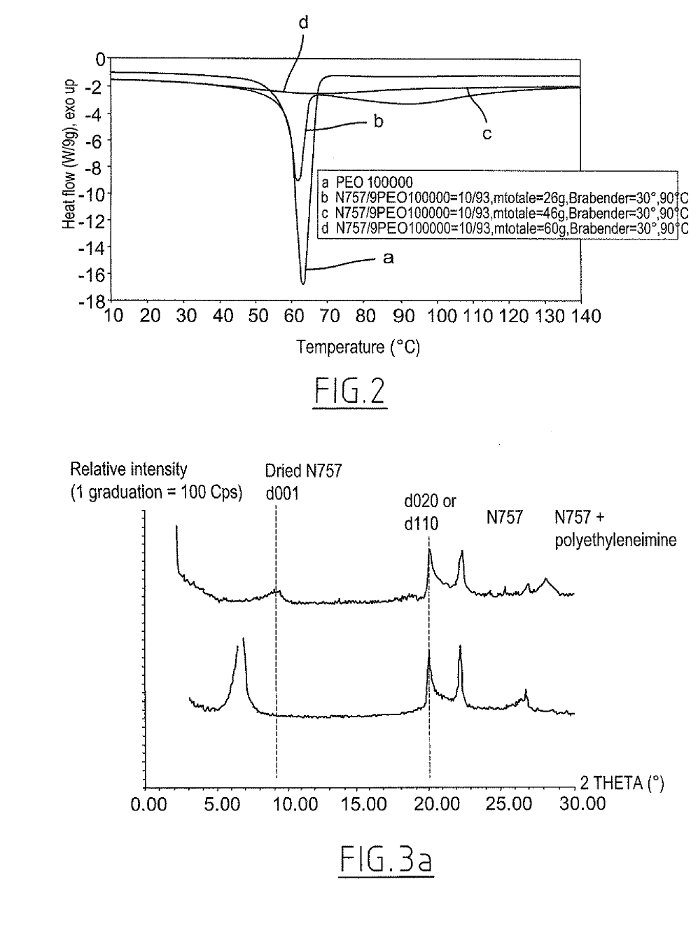

The mixed product was then analysed by DSC. The results are shown in FIG. 2. The curves a, b, c and d indicate the results obtained for the uncombined POE, and for a N757-POE mixture with a mass of 26 g, 46 g and 60 g respectively.

If the mass added to the mixing chamber increases from 26 g to 46 g, the torque also increases. This means that the shear of the elements in the mixture increases, and therefore the POE is inserted well into the N757, corresponding to the disappearance of the endothermic peak of POE on the DSC curve of the mixture thus obtained.

But when the mass added to the Brabender chamber exceeds the capacity of the mixing chamber (when the mass is equal to 60 g), the mixing is of a lower quality, is less homogeneous or not as fast, and the mixture thus shows a small endothermic peak of the fusion of the uncombined POE.

Mixing the N757-POE mixture in the Brabender mixer is therefore better for a mass which is capable of filling the mixing chamber without, however, exceeding the capacity thereof.

### Example 4

### Optimisation of the Process in Example 2

### Effect of the Duration of Mixing

Various tests have been carried out, fixing the temperature (90° C.), the speed of the blades (50 revolutions per minute, i.e. an average shear rate of approximately 25 s⁻¹) and the N757/POE mass ratio=10/3, on the one hand with a mixing period of 30 minutes and, on the other hand, with a mixing period of 60 minutes. The products were analysed using X-ray diffraction.

It appears that the value of d₀₀₁ does not change with the increase in mixing time. A mixing time of 30 minutes was therefore chosen for the remaining studies.

### Example 5

### Optimisation of the Process in Example 2

Effect of Clay Particle Size Distribution after Mixing

The N757 clay and the POE were mixed directly in the Brabender mixer for 30 minutes at 90° C., without there being any prior homogenisation.

A plurality of samples was prepared using various N757/POE ratios of between 10/1 and 10/10.

In order to analyse the distribution of the sizes of the grains in the mixture, ten grams of each sample were screened for 25 minutes, with a screening power of 70/100 (Retsch, model: Vibro 58867). The results are shown in Table 1.

TABLE 1

| | Mass % vs dimension for | | | |
|---|---|---|---|---|
| | N757-POE mixtures | | | |
| | d > 112 | 71 < d < 112 | 30 < d < 71 | d < 30 |
| Sample | μm | μm | μm | μm |
| Uncombined N₇₅₇ | 0 | 35 | 65 | 0 |
| N₇₅₇/POE_{100,000} = 10/1 | 29 | 25 | 46 | 0 |
| N₇₅₇/POE_{100,000} = 10/2 | 23 | 23 | 52 | 2 |
| N₇₅₇/POE_{100,000} = 10/3 | 21 | 19 | 46 | 14 |
| N₇₅₇/POE_{100,000} = 10/4 | 30 | 24 | 36 | 10 |
| N₇₅₇/POE_{100,000} = 10/5 | 33 | 18 | 37 | 13 |
| N₇₅₇/POE_{100,000} = 10/7 | 39 | 11 | 20 | 30 |
| N₇₅₇/POE_{100,000} = | 47 | 16 | 18 | 19 |
| 10/10 | | | | |

The results in Table 1 show that the distribution of the N757 clay particle sizes depends on the concentration of POE. On the one hand, the proportion of the sizes of less than 30 μm increases significantly with the amount of POE, as a result of the mixing. On the other hand, there is a proportion of sizes greater than 112 μm, which increases when the concentration of POE in the mixture increases. Thus, introducing a mixture which has not been previously homogenised has lead to the aggregation of the N757 in the presence of the molten POE. To avoid this phenomenon of aggregation, forming a homogenised N757/POE mixture first is necessary.

### Example 6

### Modification of a Montmorillonite-Type Clay Using Poly(Ethylene Oxide) Combining the “Pestle and Mortar” and “Brabender” Methods: Method Known as “Combined”

The protocol adopted is the following: the dried N757 clay is ground (pestle and mortar) with the POE until a homogeneous mixture is obtained, then 46 grams of this mixture is mixed in the Brabender internal mixing chamber for 30 minutes at 90° C. at a speed of 50 revolutions per minute (i.e. a shear speed at the periphery of the blades of approximately 0.08 m/s).

Using this method, the size of the grains of the material obtained is less than 112 μm, in other words, the size of the grains of the N757-POE mixture did not increase in relation to those of the initial montmorillonite after mixing in the Brabender.

### Example 7

### Modification of a Montmorillonite-Type Clay Using Polyethyleneimine

### Procedure

The same procedure as that described in Example 1 was followed, replacing the POE with a PEI with a molar mass of 423 g/mol.

Two clay samples were used: the N757 montmorillonite in Example 1, and a naturally-occurring montmorillonite from Lam Dong in Vietnam, hereinafter referred to as LD.

The stoichiometric ratio is 1 montmorillonite exchange ion to 2 PEI nitrogen atoms or, per 100 g of montmorillonite, 11.2 g of PEI for the N757 and 4.8 g of PEI for the LD.

### Results

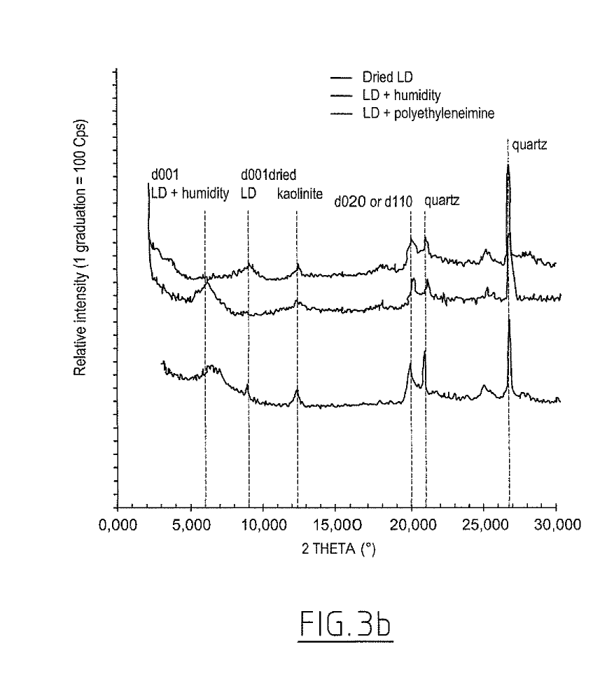

FIGS. 3a and 3b show the X-ray diffraction patterns for the uncombined clay (N757 for FIG. 3a, and LD for FIG. 3b, top curves) and for the clay-PEI mixture (lower curves) carried out as indicated above.

It appears that, in the clay-PEI mixture, the distance d₀₀₁ rises from a value of 0.97 nm for the uncombined clay to a value of 1.41 nm for the clay-PEI mixture. The increase in the distance d₀₀₁ shows that the PEI has been inserted between the clay layers, exactly the same distance being obtained for the two clays used.

### Example 8

### Preparation of a PVC/Modified Clay Nanocomposite Material and Property Characterisation

### Procedure

The PVC used is a PVC-S (obtained by polymerisation in suspension), which has a viscosity index of K=65, marketed by Solvay (France).

The modified clay, obtained according to the procedure described in Example 1, is mixed with the PVC in a ratio of 100/3 and 100/5 (parts by weight), in the molten state (T=170° C.). Mixing is carried out in a Brabender-type internal mixer comprising mixing blades, at a speed of 50 revolutions per minute for a period of 6 minutes.

The mixture obtained is then immediately put into the form of a plate using a hot flat press (T=175° C.), which makes it possible to hot-press the material in order to fill the mould properly, then to maintain pressure on the mould while it cools (the mould thus being locked in order to give a desired plate thickness). The test pieces for the standard impact tests according to the “Izod D638” (notched) standard are then cut out of the plates.

### Results

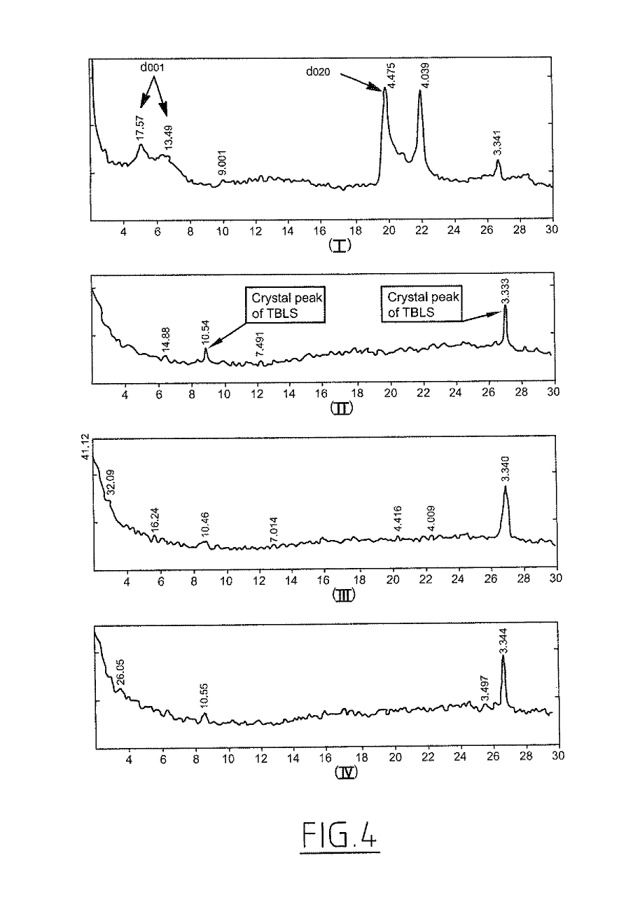

FIG. 4 shows, from top to bottom, the X-ray diffraction patterns obtained for the modified clay, consisting of the clay/POE mixture in a 10/1 ratio (X-ray diffraction pattern I), for the uncombined PVC (X-ray diffraction pattern II), for the PVC-modified clay mixture in a 100/3 ratio (X-ray diffraction pattern III), and for the PVC/modified clay mixture in a 100/5 ratio (X-ray diffraction pattern IV).

The N757-POE mixture shows two peaks corresponding to the distances 1.76 nm and 1.35 nm respectively. The distances d₀₀₁ correspond to the two structures possible with the PEO. The distance d₀₀₁ of 1.35 nm corresponds to the insertion of a single layer whilst that of 1.76 nm corresponds to a double layer of POE.

For the mixtures with the PVC, it is noted that the d₀₀₁ peaks of the N757-POE mixture disappeared and the peak characteristic of the N757 (d₀₂₀) also disappeared. (At approximately 27° C., the peak corresponding to the TBLS stabilizer (tribasic lead sulphate, marketed by Cognis) contained in the uncombined PVC is superimposed on the d₀₀₅ peak of the N757). It is noted that the structure of the N757-POE system was completely disrupted during mixing with the PVC.

### Example 9

### Preparation of a PVC/Modified Clay Nanocomposite Material

### Effect of Mixing Intensity on Impact Resistance

Mixing intensity is an essential parameter influencing the structure of the mixture, since it effects the disintegration of the clay and the dispersion in the mixture. Since impact resistance is particularly sensitive to this structure, a study was carried out in which the mixing intensity was varied simply according to the duration of the operation.

### Procedure

The PVC used is identical to that in Example 8.

The modified clay obtained according to the procedure described in Example 2 is mixed with the PVC in a ratio of 100/3 (3 parts clay to 100 parts PVC, parts by weight), in the molten state (T=170° C.). Mixing is carried out as indicated in Example 8, for periods of 4, 6, 8 and 10 minutes.

### Results

Table 2 shows that an optimum for the impact strength is obtained with a mixing period of 6 minutes.

TABLE 2

mixing time
(min)

| | 4 | 6 | 8 | 10 |
|---|---|---|---|---|
| impact strength (kJ/m²) | 3.7 | 4.4 | 3.0 | 3.0 |

### Example 10

### Viscoelastic and Mechanical Properties of the Nanocomposite Material

### Storage Modulus.

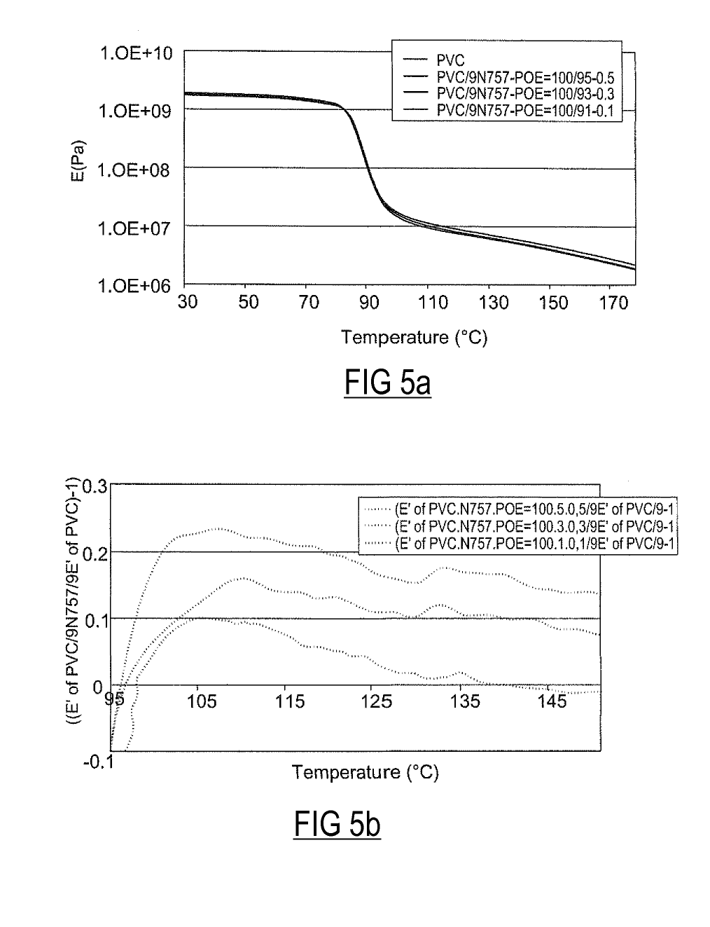

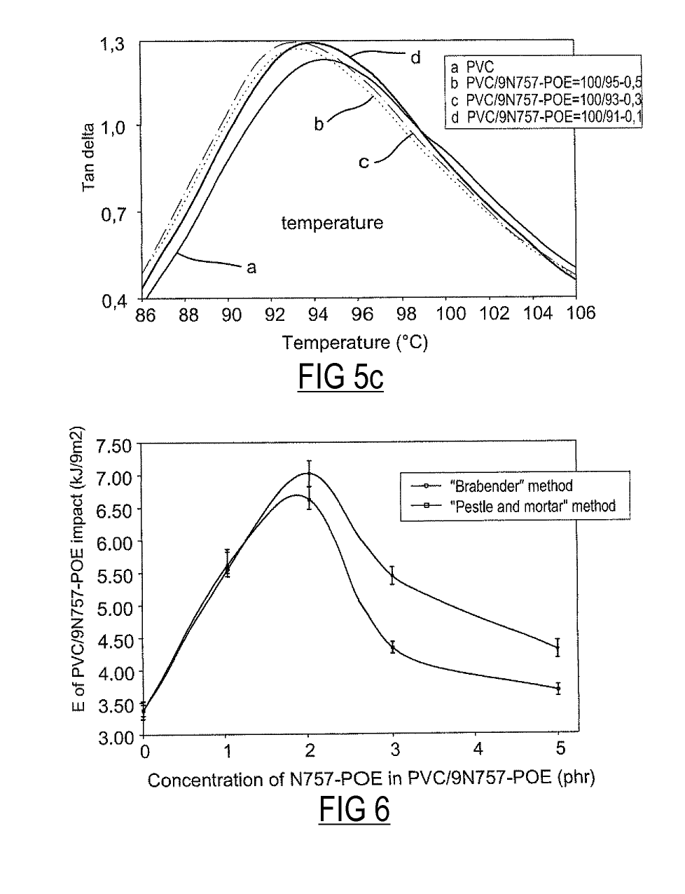

Monitoring the variation of the actual part of the modulus of elasticity as a function of the temperature characterises its thermomechanical properties. FIG. 5a shows the case of 3 (N757-POE)/PVC formulations at ratios of 1, 3 and 5 parts per 100, the clay being modified by the “combined” method described in Example 2, and the PVC being identical to that used in Example 8.

It appears that the viscoelastic behaviour is generally the same for the different N757-POE/PVC mixtures. This suggests that the presence of modified montmorillonite did not significantly reduce the temperature at which the material softens, thus maintaining the thermomechanical property of the rigid PVC. A slight reinforcement effect of the modulus, approximately between 10 and 20%, occurs in the terminal zone, beyond the glass transition zone (FIG. 5b, showing, from top to bottom, the results for the PVC/modified clay mixtures in a ratio of 100/5, 100/3 and 100/1 respectively. The reinforcement effect is shown by making the ratio of modulus E′ of the formulation containing the modified clay to the modulus E′ of the uncombined PVC, minus 1, so that the positive values correspond to the reinforcement factor.

### Mechanical Loss Factor

For the same formulations, the mechanical loss factor tan delta is shown in FIG. 5c, as a function of temperature, in the glass transition zone of the materials. The curves a, b, c, and d show respectively the results for the uncombined PVC, and for the PVC/modified clay mixtures in a ratio of 100/5, 100/3 and 100/1 respectively.

Although the glass transition temperatures of said formulations measured by DSC are the same, it appears that the combined tan delta maxima are shifted towards the low temperatures due to the presence of modified montmorillonite.

An increase in the amplitude of said maxima compared with that of the uncombined polymer is found. FIG. 5b showed that the reinforcement effect of the PVC by the modified clay decreases with the temperature, revealing a molecular mobility effect. Said two phenomena result from the formation of a network of nanofillers from the montmorillonite, joined to one another by the PEO polymer with a high molecular mass. Thus the network has mechanical energy dissipation properties, which aids the increase in impact strength.

### Example 11

### Effect of the Formulation and Mixing Conditions During the First Stage of the Process on the Impact Resistance of the N757-POE/PVC Mixtures

The N757-POE products obtained according to two variants of the first stage of the process (the “pestle and mortar” method described in Example 1 and the “combined” method described in Example 6) are mixed with the PVC (identical to that used in Example 8) in the molten state in the Brabender mixer, varying the proportion of N757/POE relative to the PVC, in order to test the impact resistance according to the “Izod D638” standard (notched).

The results are shown in FIG. 6. The curve at the top corresponds to the implementation of the “combined” method during the first stage of the process, and the curve at the bottom corresponds to the implementation of the “pestle and mortar” method. It appears that the impact resistance of N757-POE/PVC increases when the proportion of N757-POE increases, and that the impact resistance reaches its maximum value at 2% of N757-POE.

It is found that for a proportion of N757-POE equal to or greater than 2 parts per hundred of polymer, the impact strength of the samples for which the mixture was made in the “combined” method is slightly higher than for those carried out using the “pestle and mortar” method. In both cases, an optimum is obtained for the property tested.

### Example 12

### Effect of the Molar Mass and the Concentration of PEO in the Modified Clay On the Impact Resistance of the N757-POE/PVC Mixtures

Different formulations were carried out, with 100 parts of PVC (identical to that in Example 8) and 2 parts of N757-POE mixture for each. They differ in the ratio of the N757/POE mixture, which is 10/1, 10/3 and 10/5 respectively, as well as in the molar mass of the POE, which is 1,500 g/mol, 10,000 g/mol or 100,000 g/mol. The results are shown in Table 3. It is obvious that said last value is preferable for the impact resistance, for a 1-part concentration.

TABLE 3

Sample

| | | | |
|---|---|---|---|
| 0 | 1 | 3 | 5 |

(N757-POE_{1,500})/
PVC = 100/2

| | | | | |
|---|---|---|---|---|
| Ratio N₇₅₇/POE_{1,500} | 10-0 | 10-1 | 10-3 | 10-5 |
| Impact E (kJ/m²) | 3.0 | 4.4 | 3.4 | 3.3 |
| Coefficient of variation | 8% | 8% | 5% | 8% |

(N757-POE_{10,000})/
PVC = 100/2

| | | | | |
|---|---|---|---|---|
| Ratio N757/POE_{10,000} | 10-0 | 10-1 | 10-3 | 10-5 |
| Impact E (kJ/m²) | 3.0 | 4.0 | 4.1 | 4.1 |
| Coefficient of variation | 8% | 8% | 7% | 9% |

(N757-POE_{100,000})/
PVC = 100/2

| | | | | |
|---|---|---|---|---|
| Ratio N757/POE_{100,000} | 10-0 | 10-1 | 10-3 | 10-5 |
| Impact E (kJ/m²) | 3.0 | 6.6 | 4.6 | 4.5 |
| Coefficient of variation | 8% | 6% | 6% | 9% |

### Example 13

### Effect of the Nature of the Clay on the Mechanical Properties of the PVC/clay/POE Nanocomposite Material

Formulations of rigid PVC having modified clay at the ratio of 0, 1, 2, 3 and 5 parts per 100 parts of PVC were carried out according to the general conditions described in Example 8. The POE used has a mass of 100,000 g/mol, and the clays used are N757 (identical to that in Example 1) and LD (identical to that in Example 3). The clays are modified using the “combined” method in Example 2. Furthermore, by way of comparison, formulations were carried out with the non-modified clay.

The mechanical properties were determined according to the standard methods on the test pieces cut from the plates which were made in the press.

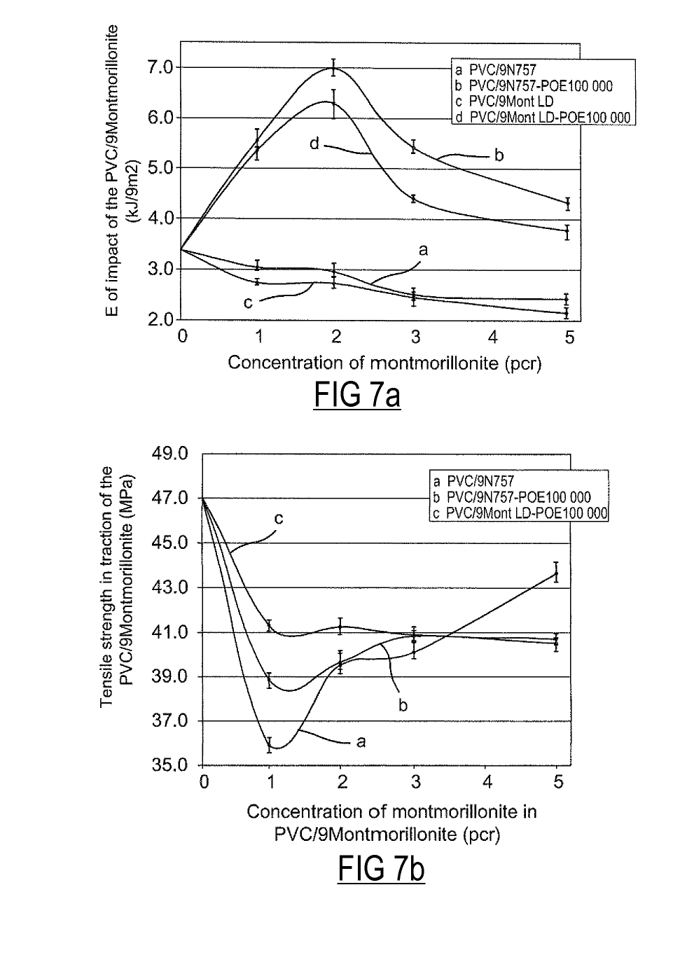

FIG. 7a shows the different impact strength values, showing the efficiency of the treatment of clays using the POE, in particular the optimum obtained for 2 parts of modified clay, with the two types of clay. The curves a, b, c and d show the results obtained for the mixtures, PVC/N757, PVC/N757 modified using POE, PVC/LD and PVC/LD modified using POE respectively.

It appears that the non-modified montmorillonite slightly reduces the impact strength, as would an ordinary mineral filler for the same low concentrations. Contrarily, modification with the POE leads to a significant increase in impact strength, up to 2 pcr. The morphology observed in this case corresponds to tactoids of different sizes and to primary particles.

For a concentration greater than 2 pcr, the increase in the rate of “faults” produced by the non-modified particles may compromise the properties.

FIG. 7b shows the different values for the tensile strength in traction as a function of the proportion, the nature and the modification of the montmorillonites. The curves a, b and c show the results for the mixtures PVC/N757, PVC/N757 modified using POE, and PVC/LD modified using POE respectively.

It is noted that the non-modified clay, in weak concentrations, significantly reduces the tensile strength, and that said phenomenon, which is known, is alleviated by using clay modified using POE. Moreover, the clay modified using LD performs the best.

1. Process for preparing a material consisting of a PVC matrix reinforced by a clay, characterised in that it comprises the following successive stages:
(1) preparation of a modified clay by mixing a natural clay with a non-volatile solvating compound, the mixture being carried out by applying at least one of the following mechanical stresses:
compression, at a speed of between 0.01 and 0.05 m/s;
shear, at a speed of between 0.05 and 5 m/s;
friction, at a speed of between 0.05 and 5 m/s;
attrition, at a speed of between 2 and 4 m/s;
(2) incorporation of the modified clay into the PVC by mixing in the molten state, the implementing conditions being such that:
the speed of compression is between 0.1 and 5 m/s;
the speed of shear is between 0.05 and 5 m/s.

2. Process according to claim 1, characterised in that stage (1) is carried out at ambient temperature.

3. Process according to claim 1, characterised in that, between stage (1) and stage (2), the mixture is heated to a temperature greater than the fusion temperature of the solvating compound.

4. Process according to claim 1, characterised in that stage (2) is carried out at a temperature of between 150° C. and 190° C.

5. Process according to claim 1, characterised in that the clay is selected from amongst a smectite, hectorite or a vermiculite.

6. Process according to claim 1, characterised in that the clay is a montmorillonite.

7. Process according to claim 1, characterised in that the solvating compound is a polymer selected from polyoxyethylene (POE) or polyethyleneimine (PEI).

8. Process according to claim 7, characterised in that the clay is a montmorillonite and the solvating agent is POE.

9. Process according to claim 7, characterised in that the solvating agent is POE, and in that the clay/POE weight ratio used during stage (1) is between 10/1 and 10/10.

10. Process according to claim 9, characterised in that the clay/POE weight ratio used during stage (1) is between 10/1 and 10/5.

11. Process according to claim 10, characterised in that the POE/clay weight ratio used during stage (1) is between 10/1 and 10/2.

12. Process according to claim 2, characterised in that, between stage (1) and stage (2), the mixture is heated to a temperature greater than the fusion temperature of the solvating compound.

13. Process according to claim 8, characterised in that the solvating agent is POE, and in that the clay/POE weight ratio used during stage (1) is between 10/1 and 10/10.
